(19) United States
(12) Patent Application Publication
(10) Pub. No.: US 2018/0324491 A1
(43) Pub. Date: Nov. 8, 2018

(54) RECOMMENDING CONTENT OF STREAMING MEDIA BY A COGNITIVE SYSTEM IN AN INFRASTRUCTURE

(71) Applicant: International Business Machines Corporation, Armonk, NY (US)

(72) Inventors: Evelyn R. Anderson, Houston, TX (US); Natalie N. Brooks Powell, Bolingbrook, IL (US); Kristen N. Conley, Kieler, WI (US); Martin G. Keen, Cary, NC (US)

(21) Appl. No.: 15/840,406

(22) Filed: Dec. 13, 2017

Related U.S. Application Data
(63) Continuation of application No. 15/584,102, filed on May 2, 2017.

(51) Int. Cl. H04N 21/442; G06K 9/00; H04N 21/4415; H04N 21/466; H04N 21/414

(52) U.S. Cl. CPC H04N 21/44218; G06K 9/00342; G06K 9/00255; H04N 21/41407; H04N 21/4415; H04N 21/4668

(57) ABSTRACT

A computer program product and a computer system for using emotional analysis to recommend streaming media content by a cognitive system in an infrastructure. The cognitive system receives, from at least one of a mobile device and a camera, information of at least one of biometrics, movement, body language, and facial expression of a user. The cognitive system derives a current emotional state of the user, based on the information of the at least one of the biometrics, the movement, the body language, and the facial expression. The cognitive system matches the current emotional state to user's one of previous emotional states stored in a repository in the infrastructure. The cognitive system sends to a streaming media service a recommendation on streaming media content to be consumed by the user, based on streaming media content that has been consumed by the user in the one of the previous emotional states.

### BACKGROUND

The present invention relates generally to a cognitive system in a cloud infrastructure, and more particularly to recommending content of streaming media by a cognitive system in a cloud infrastructure.

Media streaming services, such as Netflix, offer suggestions on TV shows and movies to a user. The suggestions offered by media streaming services based on the user's viewing history. As part of the capability of offering the suggestions, media streaming services group together shows and movies into categories, such as “suspenseful drama” and “romantic comedy”.

Today, content recommendation engines focus heavily on past viewing histories and ratings. What a user has watched and rated content influences how other content in the same category is recommended to the user. The recommendation does not take emotion of the user into consideration. However, how the user is feeling on a particular day may influence the type of content the user wishes to view.

### SUMMARY

In one aspect, a computer program product for using emotional analysis to recommend streaming media content by a cognitive system in an infrastructure is provided. The computer program product comprises a computer readable storage medium having program code embodied therewith. The program code is executable to receive from at least one of a mobile device or a camera, by the cognitive system in the infrastructure, information of at least one of biometrics, movement, body language, and facial expression of a user, wherein the at least one of the biometrics, the movement, the body language, and the facial expression is captured while the user is consuming current streaming media content provided by a streaming media service. The program code is further executable to derive, by the cognitive system, a current emotional state of the user, based on the information of the at least one of the biometrics, the movement, the body language, and the facial expression. The program code is further executable to match, by the cognitive system, the current emotional state to one of previous emotional states of the user, wherein information of the previous emotional states is stored in a repository in the infrastructure. The program code is further executable to send to the streaming media service, by the cognitive system, a recommendation on streaming media content to be consumed by the user, based on streaming media content that has been consumed by the user in the one of the previous emotional states, wherein information of the streaming media content that has been consumed by the user is stored in the repository in the infrastructure.

In another aspect, a computer system for using emotional analysis to recommend streaming media content by a cognitive system in an infrastructure is provided. The computer system comprises one or more processors, one or more computer readable tangible storage devices, and program instructions stored on at least one of the one or more computer readable tangible storage devices for execution by at least one of the one or more processors. The program instructions are executable to receive from at least one of a mobile device or a camera, by the cognitive system in the infrastructure, information of at least one of biometrics, movement, body language, and facial expression of a user, wherein the at least one of the biometrics, the movement, the body language, and the facial expression is captured while the user is consuming current streaming media content provided by a streaming media service. The program instructions are further executable to derive, by the cognitive system, a current emotional state of the user, based on the information of the at least one of the biometrics, the movement, the body language, and the facial expression. The program instructions are further executable to match, by the cognitive system, the current emotional state to one of previous emotional states of the user, wherein information of the previous emotional states is stored in a repository in the infrastructure. The program instructions are further executable to send to the streaming media service, by the cognitive system, a recommendation on streaming media content to be consumed by the user, based on streaming media content that has been consumed by the user in the one of the previous emotional states, wherein information of the streaming media content that has been consumed by the user is stored in the repository in the infrastructure.

### BRIEF DESCRIPTION OF THE SEVERAL VIEWS OF THE DRAWINGS

FIG. 1 is a diagram illustrating a system for using emotional analysis to recommend content of streaming media by a cognitive system in a cloud infrastructure, in accordance with one embodiment of the present invention.

FIG. 2 is a flowchart showing operational steps for using emotional analysis to recommend content of streaming media by a cognitive system in a cloud infrastructure, in accordance with embodiments of the present invention.

FIG. 3 is a diagram illustrating components of a computing device, in accordance with one embodiment of the present invention.

FIG. 4 depicts a cloud infrastructure environment, in accordance with one embodiment of the present invention.

FIG. 5 depicts abstraction model layers in a cloud infrastructure environment, in accordance with one embodiment of the present invention.

### DETAILED DESCRIPTION

Embodiments of the present invention disclose a system for tracking emotional data while a user is consuming content of streaming media and recommending streaming media content to be consumed by the user based on the user's current emotional state. The system monitors a user's biometrics, movement, body language, and/or facial expression as the user consumes streaming media content, such as TV shows and movies, provided by a streaming media service. The system derives an emotional state of the user from user's biometrics, movement, body language, and/or facial expression, and the system stores the emotional state of the user in an emotional state repository. The system recommends streaming media content, such as TV shows and movies, based on matching the user's current emotional state to a category of streaming media content. Alternatively, the system recommends streaming media content, such as TV shows and movies, based on matching the user's current emotional state with previous emotional states in the user's viewing history.

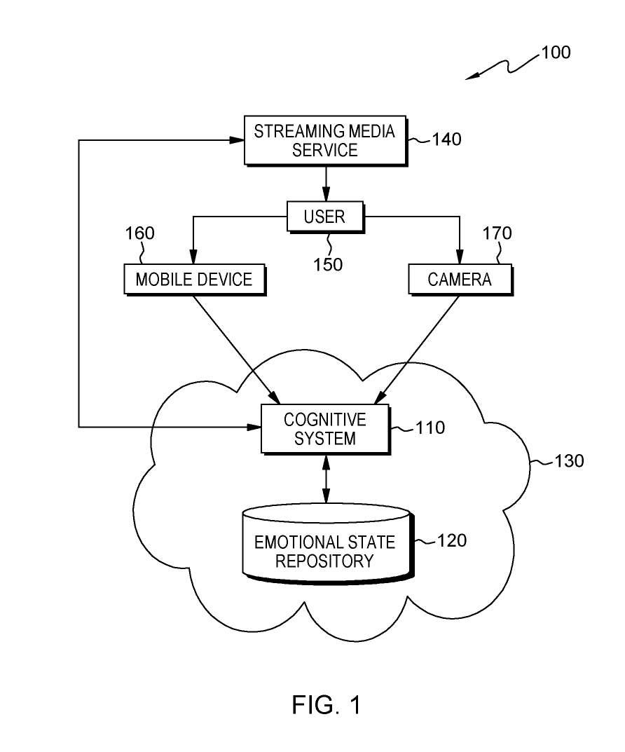

FIG. 1 is a diagram illustrating system 100 for using emotional analysis to recommend content of streaming media by cognitive system 110 in cloud infrastructure 130, in accordance with one embodiment of the present invention. System 100 comprises cognitive system 110 and emotional state repository 120 in cloud infrastructure 130. System 100 further comprises mobile device 160 and camera 170.

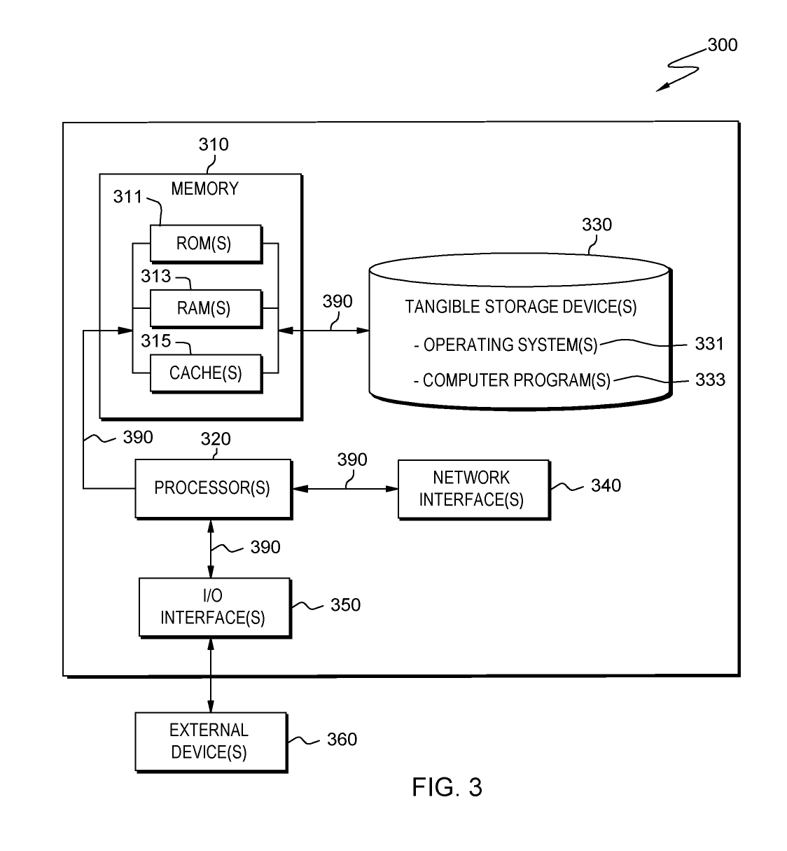

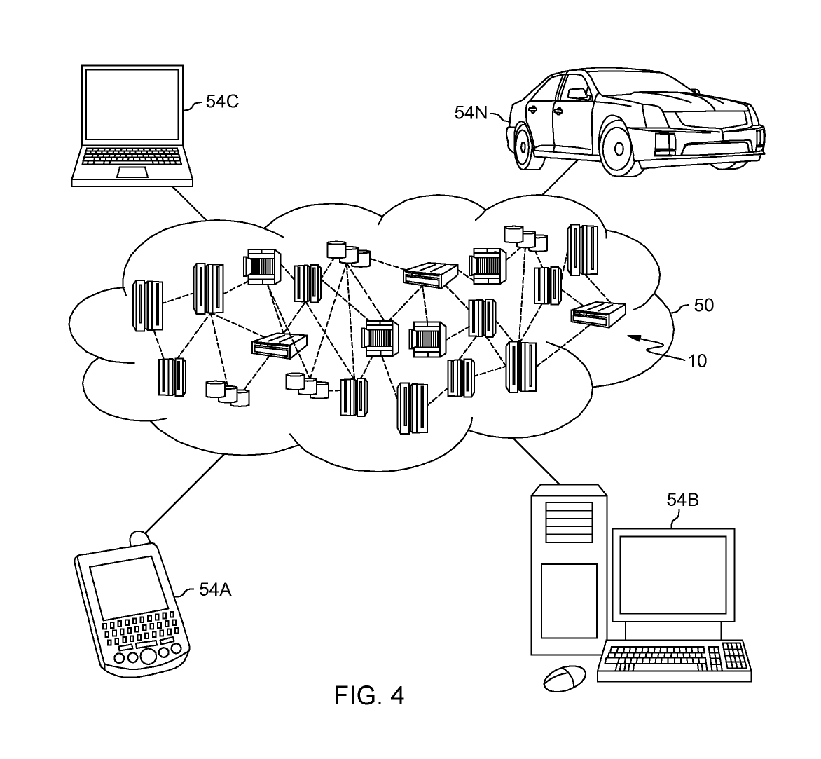

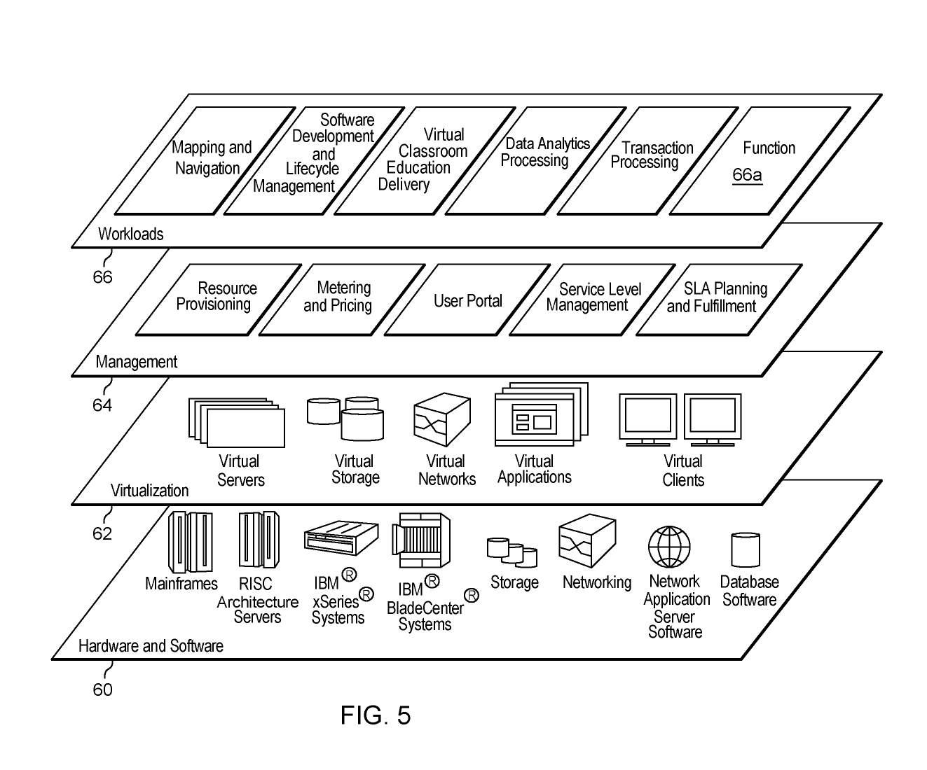

In embodiments of the present invention, cognitive system 110 is in cloud infrastructure 130. In one embodiment, cognitive system 110 resides on a physical machine as a server in cloud infrastructure 130. The physical machine as a server hosting cognitive system 110 is a computing device which is described in more detail in later paragraphs with reference to FIG. 3. In another embodiment, cognitive system 110 resides on a virtual machine or another virtualization implementation as a server in cloud infrastructure 130. The virtual machine or the virtualization implementation runs on a physical machine. Cloud infrastructure 130 is a cloud computing environment; a cloud computing environment is described in later paragraphs with reference to FIG. 4 and FIG. 5.

In system 100, user 150 consumes content of streaming media provided by streaming media service 140. Streaming media services are provided by streaming media providers, such as Netflix and Hulu. The content of the streaming media is multimedia that is constantly received by and presented to user 150 while being delivered by streaming media service 140. The content of streaming media includes, for example, TV shows and movies. User 150 uses a media player (such as a tablet or a TV set) to consume the content of the streaming media.

While user 150 is consuming the content of the streaming media (e.g., watching a TV show on a tablet or a TV set), mobile device 160 captures biometrics and/or movement of user 150. Mobile device 160 has an operating system that is capable of running computing programs. Mobile device 160 uses the following techniques to capture biometrics and/or movement of user 150. In an embodiment, mobile device 160 is a smartwatch with a sensor for capturing biometric information such as a pulse rate of user 150. The smartwatch is a computerized wristwatch and is a wearable computer. Mobile device 160 may support additional biometric sensors for measuring other biometrics such as skin temperature and blood pressure. The biometrics of user 150 can be used to detect an emotional state of user 150. In another embodiment, mobile device 160 is a smartwatch with an accelerometer and a gyroscope for capturing movement of user 150. The movement of user 150 (or how user 150 moves) is used to determine an emotional state of user 150. For example, when user 150 is excited, user 150 may make many small rapid movements; when user 150 is sad, a user 150 may keep completely still.

Camera 170 captures body language and/or facial expressions of user 150 while user 150 is consuming the content of the streaming media (e.g., watching a TV show on a tablet or a TV set). The body language and/or facial expressions of user 150 provides an indication of an emotional state of user 150. Camera 170 may be mounted on a TV set. Camera 170 may be a front facing camera on a mobile device such as a tablet.

Mobile device 160 sends information of biometrics and/or movement of user 150 to cognitive system 110 in cloud infrastructure 130. Camera 170 sends information of body language and/or facial expressions of user 150 to cognitive system 110 in cloud infrastructure 130. In one embodiment, mobile device 160 sends directly to cognitive system 110 in cloud infrastructure 130 the information of biometrics and/or movement; camera 170 sends directly to cognitive system 110 in cloud infrastructure 130 the information of body language and/or facial expressions. To send the information, mobile device 160 or camera 170 uses built-in connectivity to cognitive system 110 in cloud infrastructure 13. In another embodiment, mobile device 160 or camera 170 sends the information through an intermediary mobile device such as a mobile phone with built-in connectivity to cloud infrastructure 130. For example, mobile device 160 (such as a smartwatch) sends biometric data to a paired mobile phone and then the mobile phone transmits the information of biometrics and/or movement to cognitive system 110 in cloud infrastructure 130.

In one embodiment, cognitive system 110 in cloud infrastructure 130 receives, form mobile device 160, the information of biometrics and/or movement of user 150. In another embodiment, cognitive system 110 in cloud infrastructure 130 receives, form camera 170, the information of body language and/or facial expressions of user 150. Cognitive system 110 in cloud infrastructure 130 also receives, form streaming media service 140, information of the streaming media content that user 150 is consuming.

Upon receiving the information of biometrics and/or movement form mobile device 160 or receiving the information of body language and/or facial expressions from camera 170, cognitive system 110 in cloud infrastructure 130 derives an emotional state of user 150, based on at least one of the biometrics, the movement, body language, and facial expressions. Deriving the emotional state through analysis of a user's metrics, such as movement, biometrics, and others, has been a known technique. For example, a previous study by Schut et al (“Biometrics for Emotion Detection (BED): Exploring the combination of Speech and ECG”, Proceedings of the 1st International Workshop on Bio-inspired Human-Machine Interfaces and Healthcare Applications B-Interface 2010) describes how heart rate variability, movement analysis, and frequency of speech indicate a person's experienced emotions.

In emotional state repository 120 in cloud infrastructure 130, cognitive system 110 in cloud infrastructure 130 stores information of the emotional state and information of the streaming media content that user 150 is consuming. In emotional state repository 120, cognitive system 110 stores historical data of emotional states of user 150 and historical data of corresponding streaming media content that user 150 has consumed previously at the respective emotional states.

Cognitive system 110 in cloud infrastructure 130 recommends streaming media content to be consumed by user 150, based on the current emotional state of user 150. Cognitive system 110 in cloud infrastructure 130 sends a recommendation to streaming media service 140. Streaming media service 140 provides the recommendation to user 150.

In one embodiment, cognitive system 110 in cloud infrastructure 130 checks information of streaming media categories stored in emotional state repository 120 and matches the current emotional state of user 150 to a streaming media category suitable for the current emotional state. Cognitive system 110 makes a recommendation on streaming media content to be consumed by user 150, based on the streaming media category suitable for the current emotional state of user 150. Cognitive system 110 sends the recommendation to streaming media service 140. In this embodiment, cognitive system 110 recommends content of streaming media that reflects the current emotional state of user 150. For example, if user 150 is in a happy mood, recommend streaming media content is chosen from a category classified as light-hearted.

In another embodiment, cognitive system 110 in cloud infrastructure 130 matches the current emotional state to one of previous emotional states of user 150. The historical data of the previous emotional states of user 150 and historical data of corresponding streaming media content that user 150 has consumed at the previous emotional states are stored in emotional state repository 120 in cloud infrastructure 130. Cognitive system 110 sends to streaming media service 140 a recommendation on streaming media content to be consumed by user 150; the recommendation is based on content that has been consumed by user 150 in the one of the previous emotional states. In this embodiment, the recommendation is based on the content that has been previously consumed when user 150 has been in the same emotional state. For example, user 150 is in a relaxed emotional state; if cognitive system 110 observes from the viewing history that user 150 predominately watches Sci-Fi shows when user 150 relaxes, then cognitive system 110 recommends the category of Sci-Fi shows for user 150 to consume.

In yet another embodiment, in conjunction with making a recommendation based on the emotional state of user 150, cognitive system 110 may analyze ratings given by user 150 to content of streaming media. From the ratings, cognitive system 110 derives a correlation between the emotional state and the ratings; for example, when user 150 is in certain moods, user 150 responds particularly positively or negatively to certain types of content. When cognitive system 110 makes the recommendation based on the current emotional state, the correlation is reflected in the recommendation.

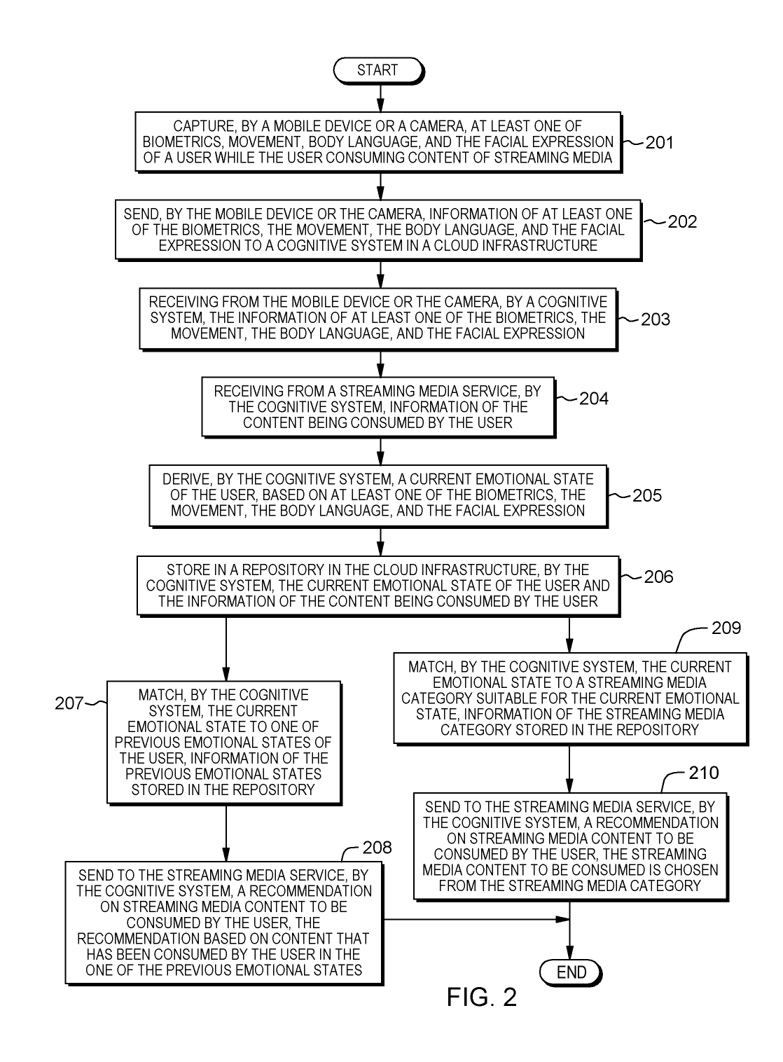

FIG. 2 is a flowchart showing operational steps for using emotional analysis to recommend content of streaming media by cognitive system 110 in cloud infrastructure 130 shown in FIG. 1, in accordance with embodiments of the present invention.

In one embodiment, mobile device 160 (shown in FIG. 1) at step 201 captures biometrics of user 150 (shown in FIG. 1) while user 150 is consuming content of steaming media. Mobile device 160, such as a smartwatch, comprises a sensor to capture biometric information such as a pulse rate of user 150. Mobile device 160, such as a smartwatch, may support additional biometric sensors for capturing other biometric information of user 150, such as skin temperature and blood pressure. In another embodiment, mobile device 160 at step 201 captures movement of user 150 while user 150 is consuming content of steaming media. Mobile device 160, such as a smartwatch, comprises an accelerometer and a gyroscope for capturing movement of user 150. In yet another embodiment, camera 170 at step 201 captures body language and/or facial expressions of user 150 while user 150 is consuming content of steaming media. For example, camera 170 may be mounted on a TV set, or may be a front facing camera on a mobile device such as a tablet.

In one embodiment, at step 202, mobile device 160 sends information of the biometrics of user 150 to cognitive system 110 in cloud infrastructure 130. The biometrics of user 150 is captured by mobile device 160 (such as a smartwatch) at step 201. In another embodiment, at step 202, mobile device 160 sends information of movement of user 150 to cognitive system 110 in cloud infrastructure 130. The movement of user 150 is captured by mobile device 160 (such as a smartwatch) at step 201. In yet another embodiment, camera 170 sends information of the body language of user 150 to cognitive system 110 in cloud infrastructure 130. The body language of user 150 is captured by camera 170 at step 201. In yet another embodiment, camera 170 sends information of the facial expressions of user 150 to cognitive system 110 in cloud infrastructure 130. The facial expressions of user 150 is captured by camera 170 at step 201.

In one embodiment, to send the information of at least one of the biometrics, the movement, the body language, and facial expressions to cognitive system 110, mobile device 140 or camera 170 at step 202 uses built-in connectivity to cognitive system 110 in cloud infrastructure 130. In another embodiment, mobile device 140 or camera 170 sends the information through an intermediary mobile device (such as a mobile phone) which has built-in connectivity to cognitive system 110 in cloud infrastructure 130.

At step 203, from mobile device 160 and/or camera 170, cognitive system 110 in cloud infrastructure 130 receives the information of at least one of the biometrics, the movement, the body language, and facial expressions of user 150.

At step 204, from streaming media service 140, cognitive system 110 in cloud infrastructure 130 receives information of the content of streaming media. The content of streaming media is being consumed by user 150 when at least one of the biometrics, the movement, the body language, and facial expressions is captured.

At step 205, cognitive system 110 in cloud infrastructure 130 derives a current emotional state of user 150, based on at least one of the biometrics, the movement, the body language, and facial expressions of user 150. At step 206, cognitive system 110 in cloud infrastructure 130 stores, in emotional state repository 120 in cloud infrastructure 130 (shown in FIG. 1), the current emotional state of user 150 and the information of the content of streaming media. The information of the content of streaming media is received by cognitive system 110 at step 204.

In response to determining the current emotional state of user 150, cognitive system 110 in cloud infrastructure 130 provides a recommendation on streaming media content to be consumed by user 150.

In one embodiment of providing a recommendation by cognitive system 110, at step 207, cognitive system 110 in cloud infrastructure 130 matches the current emotional state to one of previous emotional states of user 150. Cognitive system 110 uses historical data of the previous emotional states of user 150 and the corresponding streaming media content previously consumed by user 150. The historic data is stored in emotional state repository 120 in cloud infrastructure 130. At step 208, cognitive system 110 in cloud infrastructure 130 sends to streaming media service 140 a recommendation on streaming media content to be consumed by user 150, based on based on content that has been previously consumed by user 150 in the one of the previous emotional states.

In another embodiment of providing a recommendation by cognitive system 110, at step 209, cognitive system 110 matches the current emotional state of user 150 to a streaming media category that is suitable for the current emotional state. Information of the streaming media category is stored in emotional state repository 120. For example, if the current emotional state is a happy mood, cognitive system 110 matches the current emotional state of the happy mood to a category of light-hearted streaming media content. At step 210, cognitive system 110 sends to streaming media service 140 a recommendation on streaming media content to be consumed by user 150, wherein the streaming media content to be consumed is chosen from the streaming media category (which is matched at step 209). In this embodiment, the recommended content of streaming media reflects the current emotional state of user 150. For example, cognitive system 110 sends the recommendation including streaming media content chosen from the category of light-hearted; at step 209 the category is determined to be suitable for the current emotional state of the happy mood.

FIG. 3 is a diagram illustrating components of computing device 300, in accordance with one embodiment of the present invention. It should be appreciated that FIG. 3 provides only an illustration of one implementation and does not imply any limitations with regard to the environment in which different embodiments may be implemented.

Referring to FIG. 3, computing device 300 includes processor(s) 320, memory 310, and tangible storage device(s) 330. In FIG. 3, communications among the above-mentioned components of computing device 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330. Cognitive system 110 (shown in FIG. 1) resides on one or more computer readable tangible storage device(s) 330 on a computer or server in cloud infrastructure 130.

Computing device 300 further includes I/O interface(s) 350. I/O interface(s) 350 allows for input and output of data with external device(s) 360 that may be connected to computing device 300. Computing device 300 further includes network interface(s) 340 for communications between computing device 300 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices are used by cloud consumers, such as mobile device 54A (for example mobile device 160 as shown in FIG. 1), desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes, RISC (Reduced Instruction Set Computer) architecture based servers, servers, blade servers, storage devices, and networks and networking components. In some embodiments, software components include network application server software and database software.

Virtualization layer 62 provides an abstraction layer from which the following examples of virtual entities may be provided: virtual servers, virtual storage, virtual networks, including virtual private networks, virtual applications and operating systems, and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User Portal provides access to the cloud computing environment for consumers and system administrators. Service Level Management provides cloud computing resource allocation and management such that required service levels are met. Service Level Agreement (SLA) Planning and Fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: Mapping and Navigation, Software Development and Lifecycle Management, Virtual Classroom Education Delivery, Data Analytics Processing, Transaction Processing, and functionality according to the present invention (Function 66a). Function 66a in the present invention is the functionality of cognitive system 110 in cloud infrastructure 130 shown in FIG. 1. Cognitive system 110 in cloud infrastructure 130 has been discussed in detail in previous paragraphs of this document.

1. A computer program product for using emotional analysis to recommend streaming media content by a cognitive system in an infrastructure, the computer program product comprising a computer readable storage medium having program code embodied therewith, the program code executable to:
receive from at least one of a mobile device and a camera, by the cognitive system in the infrastructure, information of at least one of biometrics, movement, body language, and facial expression of a user, wherein the at least one of the biometrics, the movement, the body language, and the facial expression is captured by the at least one of the mobile device and the camera while the user is consuming current streaming media content provided by a streaming media service;
derive, by the cognitive system, a current emotional state of the user, based on the information of the at least one of the biometrics, the movement, the body language, and the facial expression;
match, by the cognitive system, the current emotional state to one of previous emotional states of the user, wherein information of the previous emotional states is stored in a repository in the infrastructure; and
send to the streaming media service, by the cognitive system, a recommendation on streaming media content to be consumed by the user, wherein the cognitive system provides the recommendation to the streaming media service based on streaming media content that has been consumed by the user in the one of the previous emotional states, wherein information of the streaming media content that has been consumed by the user is stored in the repository in the infrastructure.

2. The computer program product of claim 1, further comprising the program code executable to:
receive from the streaming media service, by the cognitive system, information of the current streaming media content.

3. The computer program product of claim 1, further comprising the program code executable to:
store in the repository in the infrastructure, by the cognitive system, the current emotional state in the repository in the infrastructure and information of the current streaming media content, wherein the information of the current streaming media content is received from the streaming media service.

4. The computer program product of claim 1, further comprising the program code executable to:
capture, by the mobile device, at least one of the biometrics and the movement of the user while the user is consuming the current streaming media content provided by the streaming media service; and
send to the cognitive system in the infrastructure, by the mobile device, information of the at least one of the biometrics and the movement of the user, through built-in connectivity of the mobile device to the cognitive system in the infrastructure.

5. The computer program product of claim 1, further comprising the program code executable to:
capture, by the mobile device, at least one of the biometrics and the movement of the user while the user is consuming the current streaming media content provided by the streaming media service; and
send to an intermediary mobile device, by the mobile device, information of the at least one of the biometrics and the movement of the user; and
send to the cognitive system in the infrastructure, by the intermediary mobile device, the information of the at least one of the biometrics and the movement of the user, through built-in connectivity of the intermediary mobile device to the cognitive system in the infrastructure.

6. The computer program product of claim 1, wherein the mobile device is a smartwatch comprising one or more sensors for capturing the biometrics of the user.

7. The computer program product of claim 1, wherein the mobile device is a smartwatch comprising an accelerometer and a gyroscope for capturing the movement of the user.

8. The computer program product of claim 1, further comprising the program code executable to:
capture, by the camera, at least one of the body language and the facial expression of the user while the user is consuming the current streaming media content provided by the streaming media service; and
send to the cognitive system in the infrastructure, by the camera, information of the at least one of the body language and the facial expression, through built-in connectivity of the camera to the cognitive system in the infrastructure.

9. The computer program product of claim 1, further comprising the program code executable to:
capture, by the camera, at least one of the body language and the facial expression of the user while the user is consuming the current streaming media content provided by the streaming media service; and
send to an intermediary mobile device, by the camera, information of the at least one of the body language and the facial expression, through built-in connectivity of the camera to the cognitive system in the infrastructure; and
send to the cognitive system in the infrastructure, by the intermediary mobile device, the information of the at least one of the body language and the facial expression of the user, through built-in connectivity of the camera to the cognitive system in the infrastructure.

10. The computer program product of claim 1, wherein the camera is mounted on or built in a streaming media player.

11. A computer system for using emotional analysis to recommend streaming media content by a cognitive system in an infrastructure, the computer system comprising:
one or more processors, one or more computer readable tangible storage devices, and program instructions stored on at least one of the one or more computer readable tangible storage devices for execution by at least one of the one or more processors, the program instructions executable to:
receive from at least one of a mobile device and a camera, by the cognitive system in the infrastructure, information of at least one of biometrics, movement, body language, and facial expression of a user, wherein the at least one of the biometrics, the movement, the body language, and the facial expression is captured by the at least one of the mobile device and the camera while the user is consuming current streaming media content provided by a streaming media service;
derive, by the cognitive system, a current emotional state of the user, based on the information of the at least one of the biometrics, the movement, the body language, and the facial expression;
match, by the cognitive system, the current emotional state to one of previous emotional states of the user, wherein information of the previous emotional states is stored in a repository in the infrastructure; and
send to the streaming media service, by the cognitive system, a recommendation on streaming media content to be consumed by the user, wherein the cognitive system provides the recommendation to the streaming media service based on streaming media content that has been consumed by the user in the one of the previous emotional states, wherein information of the streaming media content that has been consumed by the user is stored in the repository in the infrastructure.

12. The computer system of claim 11, further comprising the program instructions executable to:
receive from the streaming media service, by the cognitive system, information of the current streaming media content.

13. The computer system of claim 11, further comprising the program instructions executable to:
store in the repository in the infrastructure, by the cognitive system, the current emotional state in the repository in the infrastructure and information of the current streaming media content, wherein the information of the current streaming media content is received from the streaming media service.

14. The computer system of claim 11, further comprising the program instructions executable to:
capture, by the mobile device, at least one of the biometrics and the movement of the user while the user is consuming the current streaming media content provided by the streaming media service; and
send to the cognitive system in the infrastructure, by the mobile device, information of the at least one of the biometrics and the movement of the user, through built-in connectivity of the mobile device to the cognitive system in the infrastructure.

15. The computer system of claim 11, further comprising the program instructions executable to:
capture, by the mobile device, at least one of the biometrics and the movement of the user while the user is consuming the current streaming media content provided by the streaming media service; and
send to an intermediary mobile device, by the mobile device, information of the at least one of the biometrics and the movement of the user; and
send to the cognitive system in the infrastructure, by the intermediary mobile device, the information of the at least one of the biometrics and the movement of the user, through built-in connectivity of the intermediary mobile device to the cognitive system in the infrastructure.

16. The computer system of claim 11, wherein the mobile device is a smartwatch comprising one or more sensors for capturing the biometrics of the user.

17. The computer system of claim 11, wherein the mobile device is a smartwatch comprising an accelerometer and a gyroscope for capturing the movement of the user.

18. The computer system of claim 11, further comprising the program instructions executable to:
capture, by the camera, at least one of the body language and the facial expression of the user while the user is consuming the current streaming media content provided by the streaming media service; and
send to the cognitive system in the infrastructure, by the camera, information of the at least one of the body language and the facial expression, through built-in connectivity of the camera to the cognitive system in the infrastructure.

19. The computer system of claim 11, further comprising the program instructions executable to:
capture, by the camera, at least one of the body language and the facial expression of the user while the user is consuming the current streaming media content provided by the streaming media service; and
send to an intermediary mobile device, by the camera, information of the at least one of the body language and the facial expression, through built-in connectivity of the camera to the cognitive system in the infrastructure; and
send to the cognitive system in the infrastructure, by the intermediary mobile device, the information of the at least one of the body language and the facial expression of the user, through built-in connectivity of the camera to the cognitive system in the infrastructure.

20. The computer system of claim 11, wherein the camera is mounted on or built in a streaming media player.
